(19) United States
(12) Patent Application Publication
(10) Pub. No.: US 2009/0028734 A1
(43) Pub. Date: Jan. 29, 2009

(54) PUMP ASSEMBLY WITH PRESSABLE HEAD

(76) Inventor: Sen-Li TSENG, Taichung City (TW)

Correspondence Address: Chien-Hui Su, P. O. Box 70-121 Taichung, Taichung City, 40899, TW

(21) Appl. No.: 11/781,967

(22) Filed: Jul. 24, 2007

(51) Int. Cl. B67D 5/42

(52) U.S. Cl. 417/554

(57) ABSTRACT

A pump assembly with a pressable head comprises a push tube, an inner tube, a stop valve, and an outer tube; a top of the push tube passing through the outer tube; the push tube being communicated to the inner tube; a bottom of the inner tube being formed with an annular plug; the plug of the inner tube having a plurality of via holes with inclined inner walls; a top of the inner tube having a stop valve; the stop valve being a flat structure; a periphery of the stop valve being formed with an elastic structure; by the elastic deformation of the periphery of the stop valve, the stop valve will tightly adhere to an inner wall of the outer tube; an interior of the outer tube having a stepped structure with a larger size at an upper side and a smaller size at a lower side.

### FIELD OF THE INVENTION

The present invention relates to pump assemblies, and particularly to a pump assembly with a pressable head, wherein the walls of the components of the pump assembly will be protected from cracking so that the liquid in the container assembled with the pump assembly will be tightly sealed in the container; and thus the operation of sucking liquid is performed effectively.

### BACKGROUND OF THE INVENTION

The prior art liquid cleaning container is a suction tube in a lower end of a stepped tube. An upper end of a stepped tube is a tube cover and a rotary cover. A piston is received in the stepped tube and a seat with a sealed cover end is installed. A via hole is at a lower end of the stepped tube. A top of the seat has a middle connecting tube. An upper connected tube is connected to the middle connecting tube and then the upper connecting tube is connected to a spray head. A steel ball is installed between a small tube at a lower end of the stepped tube and at an upper end of the stepped tube. A spring is installed in the middle connecting tube. An upper end of the spring is inserted into the lower end of the seat. Therefore, by pressing the spray head, the piston will move downwards. Then the spray head is released so that the piston will generates suction force by the ejection force from the spring. Then the steel ball will be pushed away so that the emulsion in the container will suck into the suction tube. When the head is pressed again, the piston moves downwards and then the emulsion flows out from the via hole of the seat into the middle connecting tube so as to be extruded out from the spraying head.

However, the prior art has the defects that if the emulsion contains particles, the walls of the components of the containers will be worn and cracked so that the operation is inefficient, even for a long time, the suction function is destroyed.

### SUMMARY OF THE INVENTION

Accordingly, the primary object of the present invention is to provide a pump assembly with a pressable head, wherein the walls of the components of the pump assembly will be protected from cracking so that the liquid in the container assembled with the pump assembly will be tightly sealed in the container; and thus the operation of sucking liquid is performed effectively.

To achieve above objects, the present invention provides a pump assembly with a pressable head, comprising a push tube, an inner tube, a stop valve, and an outer tube; the push tube having a tubular structure; a top of the push tube passing through the outer tube; the push tube being communicated to the inner tube; the inner tube being a tubular structure; a bottom of the inner tube being formed with an annular plug; the plug of the inner tube having a plurality of via holes which inclined inner walls; a top of the inner tube having a stop valve; the stop valve being a flat structure; a periphery of the stop valve being formed with an elastic structure; by the elastic deformation of the periphery of the stop valve, the stop valve will tightly adhere to an inner wall of the outer tube; the bottom of the stop valve being protruded with a plurality of stoppers corresponding to the via holes; and the outer tube having a tubular structure; an interior of the outer tube having a stepped structure with a larger size at an upper side and a smaller size at a lower side; a largest size of the interior of the outer tube being greater than outer sizes of the push tube and the inner tube so that the push tube and inner tube can be received in the outer tube.

The various objects and advantages of the present invention will be more readily understood from the following detailed description when read in conjunction with the appended drawing.

### BRIEF DESCRIPTION OF THE DRAWINGS

FIG. 1 is an exploded perspective view of the pump assembly with a pressable head of the present invention.

FIG. 2 is an exploded schematic view about the stop valve, inner tube and engaging unit of the present invention.

FIG. 3 is a schematic cross sectional view about the stop valve, inner tube and engaging unit of the present invention.

FIG. 4 shows an assembled view of the pump assembly with a pressable head of the present invention.

FIG. 5 is a schematic cross sectional view showing the suction operation of the present invention.

FIG. 6 is a schematic cross sectional view showing the air suction operation according to the present invention.

FIG. 7 is a schematic cross sectional view showing the extrusion operation of the present invention.

FIG. 8 is a schematic cross sectional view includes an initial state of the present invention.

FIG. 9 is a schematic cross sectional view of FIG. 8.

FIG. 10 is a schematic cross sectional view showing that the present invention is used.

FIG. 11 is a schematic cross sectional view showing a reverse state of FIG. 10.

FIG. 12 is an assembled view about the second embodiment of the present invention.

FIG. 13 is a cross section view showing the application of the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, and characteristics of the present invention, but not to be used to confine the scope and spirit of the present invention defined in the appended claims.

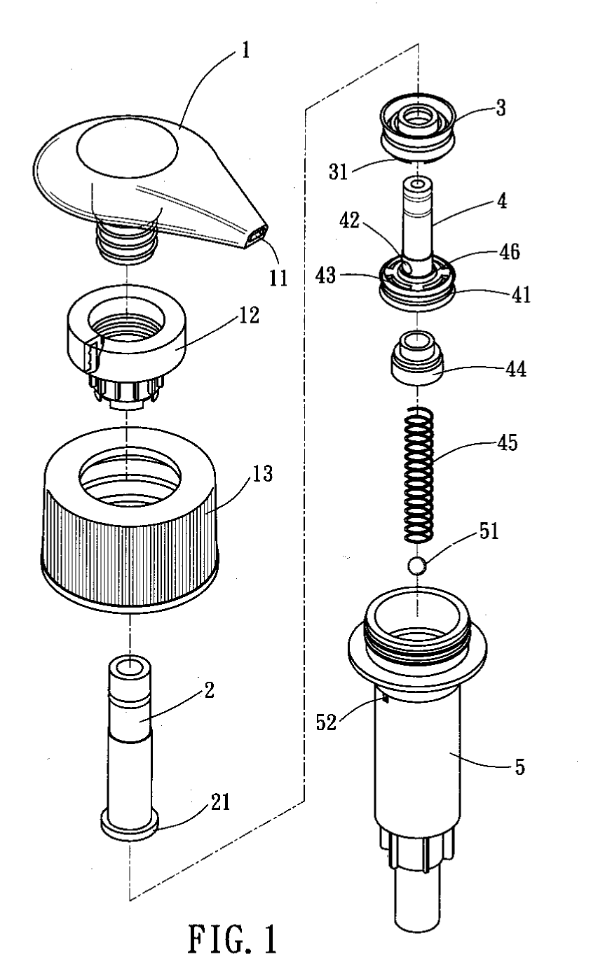

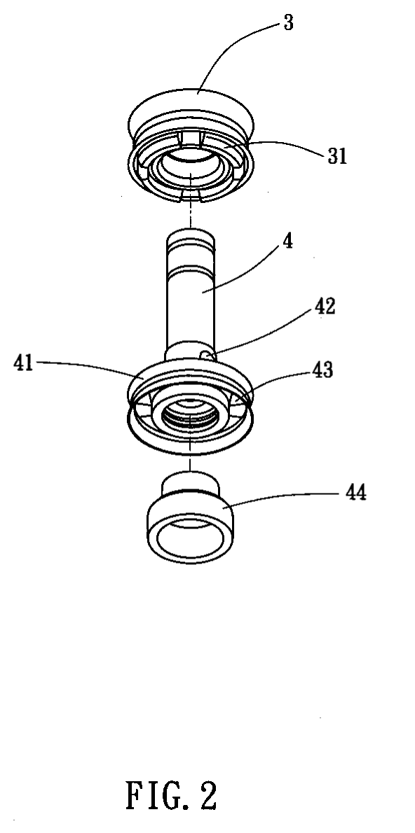

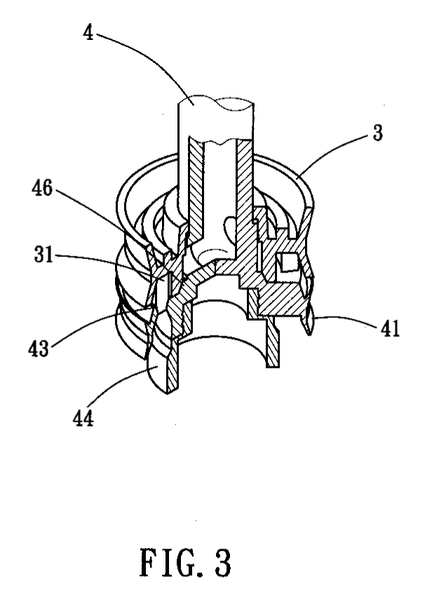

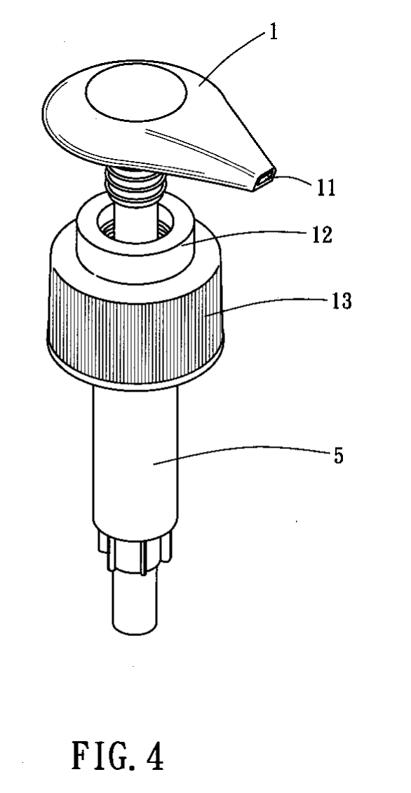

Referring to FIGS. 1 to 4, the structure of the present invention is illustrated. The present invention includes a push tube 2, an inner tube 4, a stop valve 3, and an outer tube 5.

The push tube 2 has a tubular structure. A top of the push tube 2 passes through the outer tube 5 and a sealing unit 12 and then is connected to a head 1. A lower end of the push tube 2 is installed with a shoulder 21. In assembly, the push tube 2 is communicated to the inner tube 4.

The inner tube 4 is a tubular structure. A bottom of the inner tube 4 is formed with an annular plug 41. The connection of the inner tube 4 and the plug 41 has an inclined annular rib 46. A lower end of the inner tube 4 near the plug 41 is a guide hole 42 communicated to the inner tube 4. The plug 41 of the inner tube 4 has a plurality of via holes 43 with inclined inner walls. A top of the inner tube 4 has a stop valve 3. A lower end of the inner tube 4 is assembled with an engaging unit 44.

The stop valve 3 is a flat structure. A periphery of the stop valve 3 is formed with an elastic structure. By the elastic deformation of the periphery of the stop valve 3, the stop valve 3 will tightly adhere to an inner wall of the outer tube 5. The bottom of the stop valve 3 is protruded with a plurality of stoppers 31 corresponding to the via holes 43. The inclination of the periphery of the stop valve 3 are corresponding to the via holes 43. A bottom of the stop valve 3 is inclined with a slope corresponding to that of the rib 46 so that the stop valve 3 can be tightly engaged with the plug 41.

The engaging unit 44 is engaged to a lower end of the inner tube 4. The bottom surface of the engaging unit 44 is concaved for assembling with an elastic unit 45. The elastic unit 45 resists against a lower end of the outer tube 5.

The outer tube 5 has a tubular structure. An interior of the outer tube 5 has a stepped structure with a larger size at an upper side and a smaller size at a lower side. A largest size of the interior of the outer tube 5 is greater than outer sizes of the push tube 2 and the inner tube 4 so that the push tube 2 and inner tube 4 can be received in the outer tube 5. Each of two sides of the outer tube 5 at a position with a largest inner size has an air hole 52. A smallest size of the interior of the outer tube 5 has a stop unit 53 for receiving a ball 51 which provides a check function so that fluid flows unidirectionally.

The head 1 passes through the cover 13 and the sealing unit 12 to assemble with the push tube 2. The head 1 is assembled to a container 6 by using the cover 13. The head 1 has an outlet 11 which is communicated to the push tube 2. The outlet 11 is communicated to the push tube 2. A top of the push tube 2 passes through the stop valve 3 to be assembled to the push tube 2. A lower end of the inner tube 4 is connected to the engaging unit 44. The engaging unit 44 is assembled with the elastic unit 45. The elastic unit 45 is buckled to the inner wall of the outer tube 5. The stop unit 53 at the lower side of the interior of the outer tube 5 resists against the ball 51. The push tube 2, stop valve 3, inner tube 4 and engaging unit 44 are received in the outer tube 5.

Therefore, by pressing the head 1, the push tube 2 moves downwards to drive the inner tube 4 to move downwards. The shoulder 21 of the push tube 2 resists against the stop valve 3 so that the stop valve 3 is adhered to the outer tube 5 and to move downwards. Thus, the elastic unit 45 deforms by the pressure. The liquid in the inner tube 4 in the receiving space will be compressed so that the liquid flows into the via holes 43 through the plug 41 and then flows out from the head 1. When the force applied to the head 1 disappears, the resilient force of the elastic unit 45 will eject the engaging unit 44 to drive the inner tube 4 to move upwards. Therefore, the plug 41 will move upwards to resist against the stop valve 3. Thus, the inclination of the via holes 43 of the plug 41 is corresponding to that of the stoppers 31 of the stop valve 3. The via holes 43 are engaged with the stoppers 31 tightly. Thereby, an isolation layer 7 is formed between the plug 41 and the stop valve 3 so as to retain the tight sealing effect between the inner tube 4 and the outer tube 5 even the plug 41 or the stop valve 3 is not tightly sealed with the outer tube 5 in the contact position. By the isolation layer 7, it can be retained in a tight seal state. No liquid drains out.

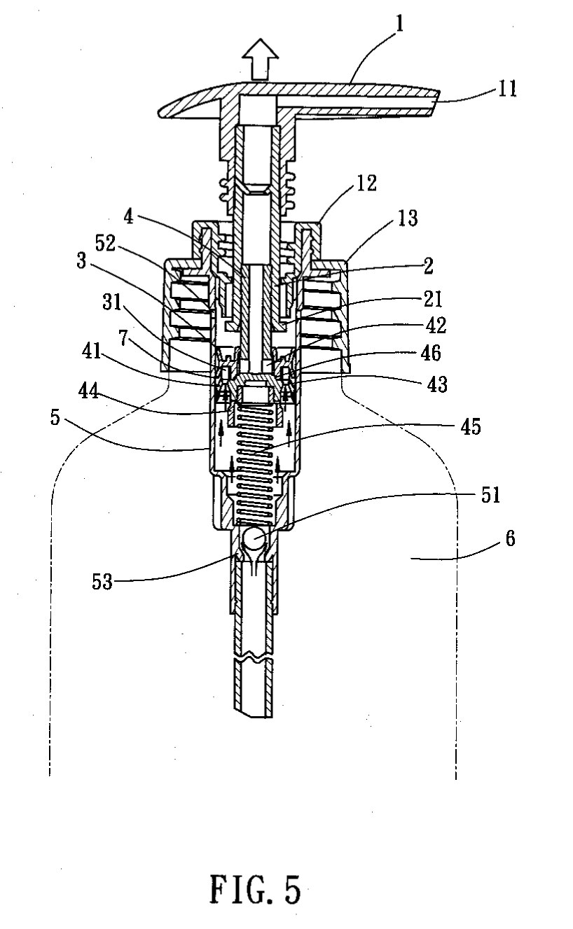

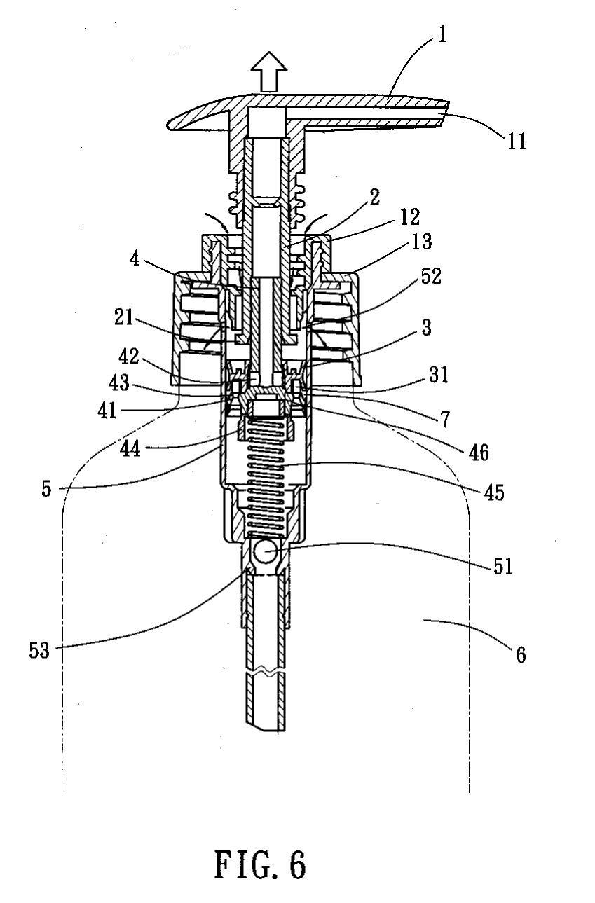

Referring to FIGS. 5 to 7, the operation of the present invention is presented. With reference to FIG. 5, the user releases the head 1 after pressing, the elastic unit 45 will push the engaging unit 44, inner tube 4 and the plug 41 to move upwards. Then, since the receiving space between the plug 41 and the outer tube 5 expands, the reduction of the pressure will generate an upward absorption force, then the ball 51 moves upwards and the liquid in the container 6 is sucked. The interior space of the container 6 is expanded to reduce the pressure. Then air is absorbed by the air hole 52 of the outer tube 5 so as to compensate the reduction space. Thereby the intake operation is complete.

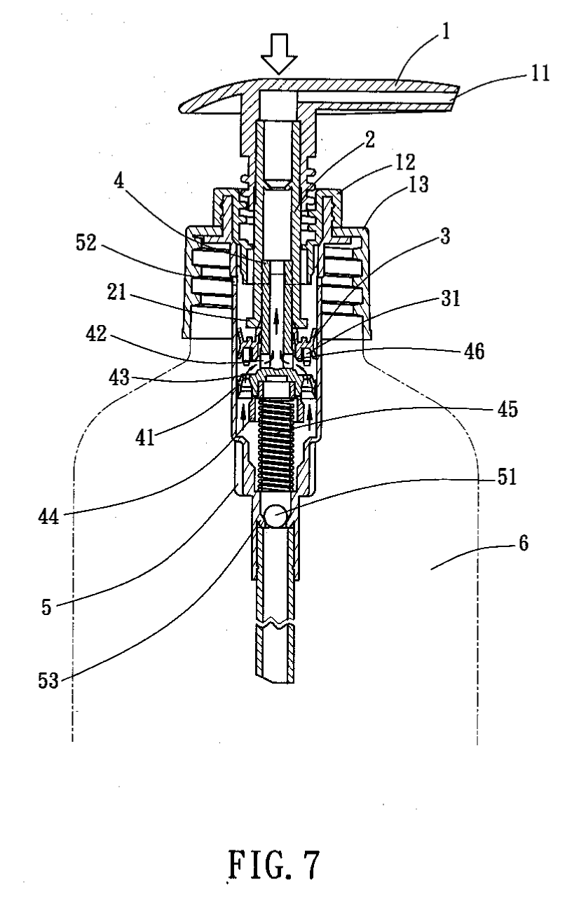

When the user presses the head 1, as shown in FIG. 7, the head 1 will extrude the push tube 2 to move axially and downwards. The push tube 2 will interact with the inner tube 4 and the plug 41 so that they move downwards. Then the shoulder 21 will resist the stop valve 3 to move downwards. The step difference will make the guide hole 42 is communicated with the inner tube 4 without being sealed by the stop valve 3. Since the plug 41 compresses the liquid originally between the plug 41 and the inner tube 4, the bottom of the outer tube 5 is sealed, and the internal liquid is guided to the guide hole 42, the inner tube 4 and the push tube 2 along the via holes 43 and then flows out from the outlet 11 of the head 1. Thus complete the action of the intake of liquid.

When the space between the plug 41 and the stop valve 3 is filled with the intake liquid, as the user releases the head 1, the elastic unit 45 will return to a position illustrated in FIG. 5. The inclination of the via holes 43 of the plug 41 is corresponding to that of the stoppers 31 of the stop valve 3, the via holes 43 are tightly engaged to the stoppers 31. Furthermore by the ribs 46 corresponding to the bottom of the stop valve 3, when the plug 41 pushes upwards, the plug 41 will engage to the stop valve 3. Therefore, the guide hole 42 will be sealed by the stop valve 3, and the isolation layer 7 is formed between the plug 41 and the stop valve 3. The present invention is mainly used to bath cleaning liquid, especially emulsion or glue. Thus, the isolation layer 7 can provide sufficient sealing effect between the plug 41 and the stop valve 3. The isolation layer 7 can fill the cracks therebetween.

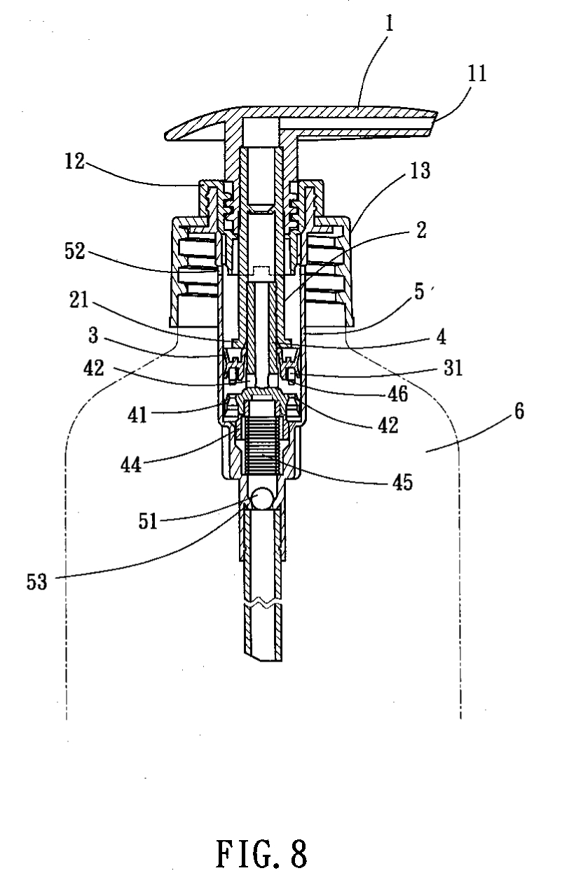

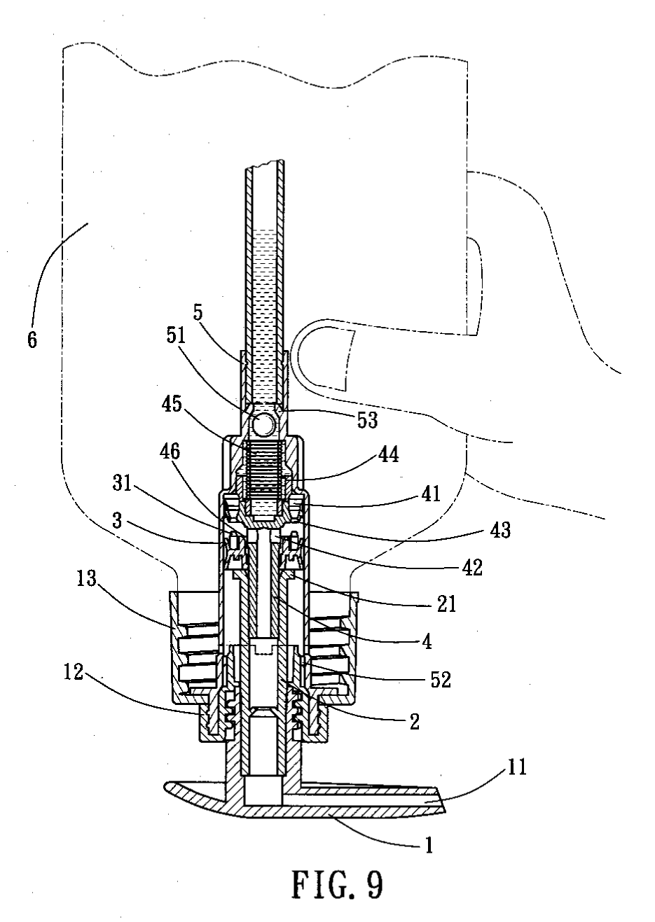

Referring to FIGS. 8 to 11, in FIG. 8, initially, the head 1 is locked to the sealing unit 12. Then the plug 41 is pressed by the head 1 to push the inner tube 4 and the engaging unit 44 to press the elastic unit 45. The engaging unit 44 resists against a wall of the outer tube 5. Referring to FIG. 9, when the container 6 is positioned reversely, the ball 51 can not resist against the stop unit 53 by the gravitational force. The liquid will flows out from the bottom of the container 6. Since the engaging unit 44 is tightly engaged with the inner tube 4, the internal liquid can not flow to the guide hole 42. Thus, no liquid drains out.

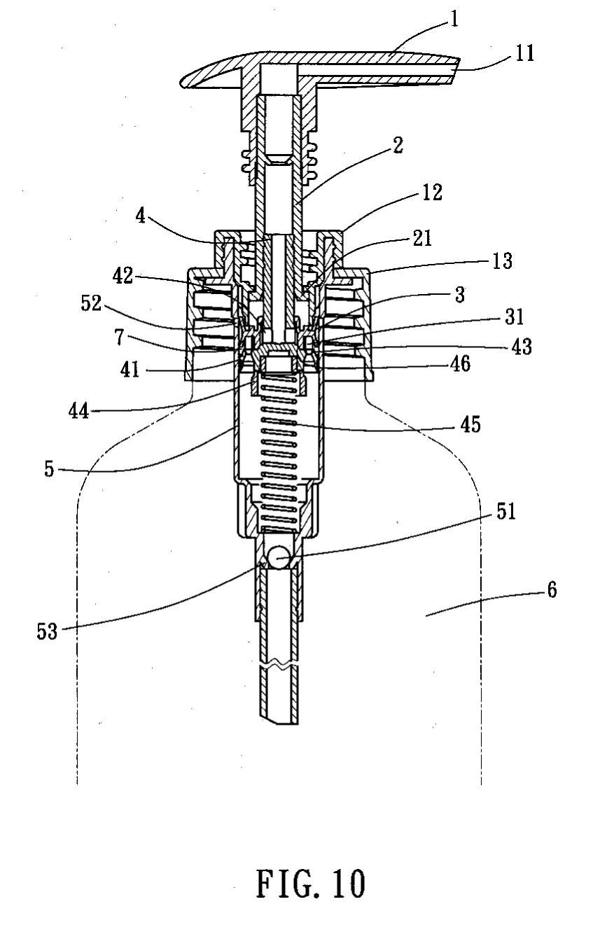

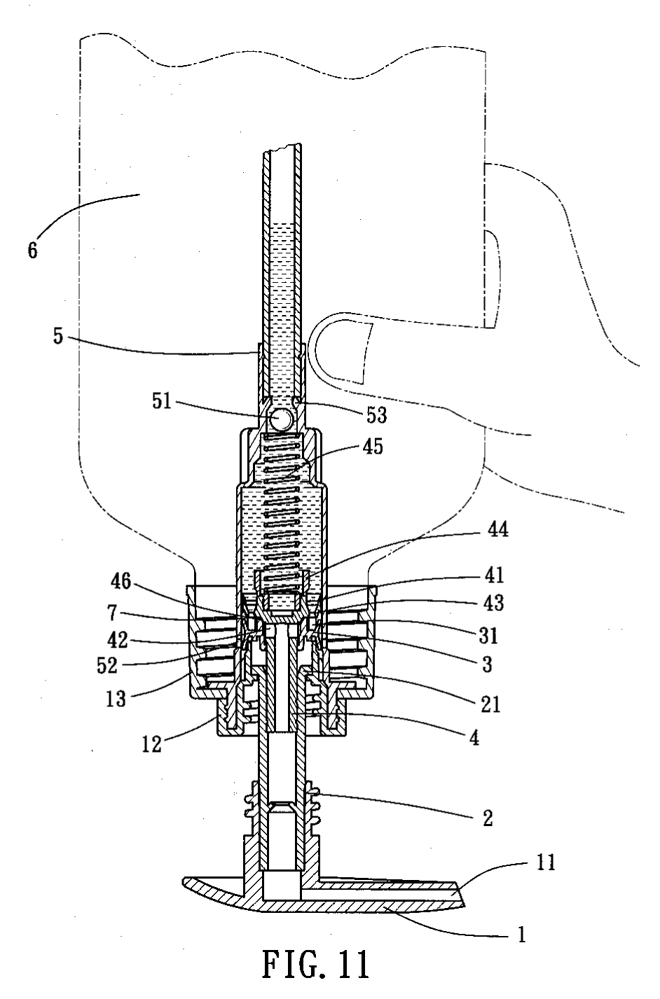

Referring to FIG. 10, when the head 1 is opened firstly, the peripheral elastic structure of the stop valve 3 will tightly engage with the inner wall of the outer tube 5. When the user presses the head 1 several times, the elastic unit 45 will return elastically to push the engaging unit 44 so as to cause the plug 41 and the inner tube 4 to move upwards. The plug 41 sucks the liquid to the outer tube 5. The via holes 43 of the inner tube 4 is engaged to the stoppers 31 of the stop valve 3 and the guide hole 42 of the inner tube 4 is sealed by the stop valve 3. Each time, the head 1 is pressed, the structure of the isolation layer 7 are enhanced so as to retain a very good sealing effect. Even in a state illustrated in FIG. 11, the ball 51 can not resist against the stop unit 53 by the effect of gravitational force. As liquid flows out from the bottom of the container 6, it can not flow out due to the isolation layer 7 between the stop valve 3 and the plug 41.

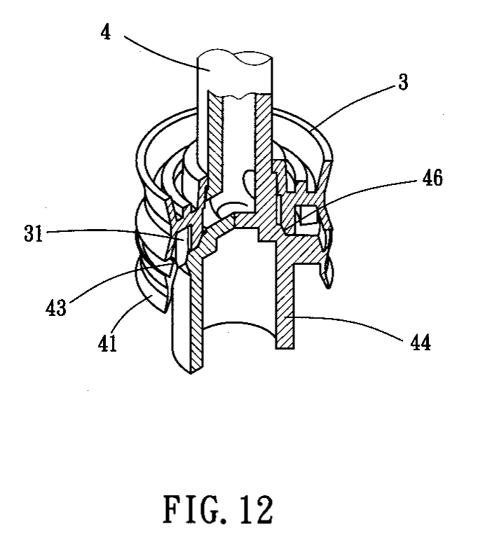

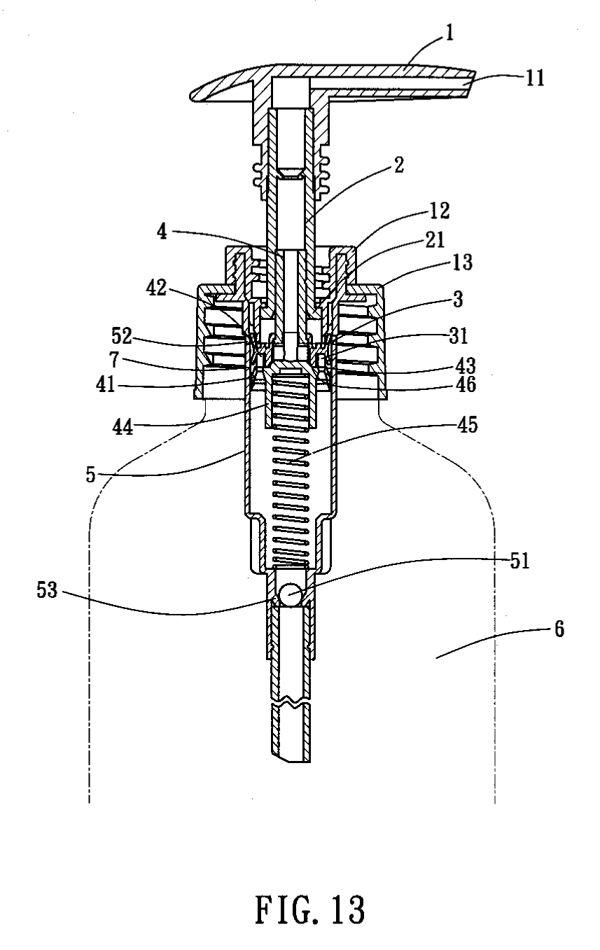

Referring to FIGS. 12 and 13, the second embodiment of the present invention is illustrated. In this embodiment, the engaging unit 44 is integrally installed with the inner tube 4 and the plug 41. An inner diameter of the engaging unit 44 is greater than that in the first embodiment so as to be used with a greater elastic unit 45. Thus, the elastic unit 45 is exactly installed in the engaging unit 44 to have the same effect. When the receiving space of the outer tube 5 is too small, while a great elastic unit 45 is necessary, if the elastic unit 45 is installed in the plug 41, it will induce that the space needed is too large. Thus the wall of the plug 41 is thick and the structure is insufficient. Thus the engaging unit 44 of the first embodiment with a greater inner diameter is installed in the plug 41 so as to retain the elasticity of the elastic unit 45. The elastic unit 45 will not shift.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A pump assembly with a pressable head, comprising a push tube, an inner tube, a stop valve, and an outer tube;
the push tube having a tubular structure; a top of the push tube passing through the outer tube; the push tube being communicated to the inner tube;
the inner tube being a tubular structure; a bottom of the inner tube being formed with an annular plug; the plug of the inner tube having a plurality of via holes with inclined inner walls; a top of the inner tube having a stop valve;
the stop valve being a flat structure; a periphery of the stop valve being formed with an elastic structure; by elastic deformation of the periphery of the stop valve, the stop valve will tightly adhere to an inner wall of the outer tube; the bottom of the stop valve being protruded with a plurality of stoppers corresponding to the via holes; and
the outer tube having a tubular structure; an interior of the outer tube having a stepped structure with a larger size at an upper side and a smaller size at a lower side; a largest size of the interior of the outer tube being greater than outer sizes of the push tube and the inner tube so that the push tube and inner tube can be received in the outer tube.

2. The pump assembly with a pressable head as claimed in claim 1, wherein a lower end of the inner tube being assembled with an engaging unit for installing with an elastic unit.

3. The pump assembly with a pressable head as claimed in claim 2, wherein the elastic unit is a spring.

4. The pump assembly with a pressable head as claimed in claim 1, wherein a connection of the inner tube and the plug has an inclined annular rib.

5. The pump assembly with a pressable head as claimed in claim 1, wherein an inclination of the periphery of the stop valve is corresponding to the via holes.

6. The pump assembly with a pressable head as claimed in claim 1, wherein the outer tube is formed with at least one air hole.

7. The pump assembly with a pressable head as claimed in claim 1, wherein an interior of the outer tube has a stop unit for receiving a ball which provides a check function so that fluid flows unidirectionally.

8. The pump assembly with a pressable head as claimed in claim 1, wherein a lower end of the inner tube near the plug is a guide hole communicated to the inner tube.

9. The pump assembly with a pressable head as claimed in claim 1, wherein a lower end of the push tube is installed with a shoulder.

10. The pump assembly with a pressable head as claimed in claim 1, wherein an engaging unit is engaged to a lower end of the inner tube.

11. The pump assembly with a pressable head as claimed in claim 1, wherein the bottom surface of the engaging unit is concaved for assembling with an elastic unit; and the elastic unit resisting against a lower end of the outer tube.

12. The pump assembly with a pressable head as claimed in claim 1, wherein a bottom of the stop valve is inclined with a slope corresponding to that of the rib so that the stop valve can be tightly engaged with the plug.
